(19) United States
(12) Patent Application Publication
(10) Pub. No.: US 2015/0309335 A1
(43) Pub. Date: Oct. 29, 2015

(54) Blue-Light-Inhibiting Resin Lens and Manufacturing Method Therefor

(71) Applicant: Guo Rong LI, Wenzhou (CN)

(72) Inventor: Guo Rong LI, Wenzhou (CN)

(73) Assignee: MEGALOWMART HOLDINGS LLC., Walnut, CA (US)

(21) Appl. No.: 14/261,429

(22) Filed: Apr. 25, 2014

(51) Int. Cl. G02C 7/10; B05D 5/06; G02B 1/18

(52) U.S. Cl. CPC G02C 7/104; G02C 7/108; G02B 1/18; B05D 5/065; G02C 2202/16

(57) ABSTRACT

A blue-light-inhibiting resin lens includes a reinforcing protective substrate and a reinforcing layer which comprises eight layers coating on a surface of a reinforcing protective substrate from lower to upper by a vacuum evaporation method; wherein reinforcing layer comprises a first layer, which is a nano-composite coating layer mixing with polyurethane acrylate and SiO2, a second layer, which is a SiO2 layer I, a third layer, which is a ZrO2 layer I, a fourth layer, which is a SiO2 layer II, a fifth layer, which is a ZrO2 layer II, a sixth layer, which is an indium-tin-metal oxide nano-coating layer, and a seventh layer, which is a SiO2 Layer III, and an eighth layer, which is a waterproof-medicine layer. And, a manufacturing method for the blue-light-inhibiting resin lens is provided.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention to a lens, and more particularly to a blue-light-inhibiting resin lens and a manufacturing method therefor.

2. Description of Related Arts

With the improvement of living standards, computers and high-definition (HD) LCD screens have been widely used, so the frequency of using computers has greatly increased. At the same time, most of people use a car for transportation.

According to “Macwelt” survey, the HD LCD screen generate less radiation than the conventional screens, wherein the brightness of the high-definition screen is too strong, so it is more likely to make our eyes hurt, and seriously causes tiredness, soreness, fever, pain and other symptoms in our eyes. The researchers noted that while the brightness of the screens achieves to [AD] 100 cd/per square meter, it will generate harmful impacts on our eyes. However, the LCD screen in the current market has the illumination intensity more than 300 cd per square meter, and some LCD screens have that of 400 cd to 500 cd per square meter.

Similarly, this is the most important problems while we are watching the LCD television. Generally speaking, we watch TV at a position that reached of 3 meters, which has exceeded the wavelength of its built-in electromagnetic sources, so the hazard for the human body can be ignored. However, our eye still feel fatigued, which is also proved that the electromagnetic radiation of the computer is not a major injury to the human's eyes.

Blue light is an important part of the visible light, but it has a short wavelength, with high frequency, and can directly penetrate the eye's lenses to the retina. LED and computer background light (artificial light sources) contains a lot of blue lights, which can make artificial lights more whiter and brighter, and some particularly bright and white light give us the feeling of the pan-blue lights, which are based on a high proportion of blue lights. In fact, in 40 years ago, scientists have found that the blue lights will damage our eyes. Over the past few decades, blue lights have already confirmed that it have a serious impact on human vision.

Recently, blue lights have a new evidence of making damages to our eyes. Blue lights will increase the light sensitivity of our visual cell and the photo oxidation thereof, so as to cause the death of the visual cells and the damage of our visions. Under aerobic conditions, the retina is stimulated by the blue lights to start the oxidation mechanism, so as to cause a severe oxidation reaction, which destroys the dynamic equilibrium of the oxidation of the body and cause the apoptosis of photoreceptor cells. It is considered that the reaction of the lipofuscin and the blue light are main reasons to cause the degeneration of the macular. A large numbers of experiments show that blue lights are able to activate the oxidation of retinal cells and initiate the apoptosis mechanism thereof, so as to cause the death and damage of the cell.

Accordingly, the present invention has advantages of having effective inhibition of the blue light with a wavelength less than 500 nm and the improvement of the transmittance of the visible light with a wavelength large than 500 nm. It is worth mentioning that under low light conditions, the present invention has a best light improvement and is a strong barrier for the blue-white light. In addition, since the present invention reduce the wavelength range of the transmittance, and the visual sense of the contours of the objects is relatively increased. In order to improve the night vision, some vehicle manufacturers and drivers installed or modified a large numbers of xenon headlights. However, these xenon headlights are inconvenience for a driver on an oncoming traffic lane. Even if the driver is driving in a main lane with brighter headlights, the high beams from other vehicles on the oncoming traffic lane will blur the driver's visions in the main lane, such that the main lane driver not only cannot see the road, but also cannot distinguish the objects in the front. Currently, there are some related night-time driving mirrors on the market, but their main principles are based on the control of the different vibration direction of the polarized lenses, so as to eliminate or reduce the principle of diffusion and reflectance. Under the premise of that the related night time driving mirrors are dyed on certain colors, the protective effects of the drivers are limited. Since the intensity of the light is still very strong, it cannot reduce the stimulation of the lights for the drivers, so it is very dangerous for the drivers.

Our eyes has dysfunction while continuously exposing in a “inappropriate light”, especially in a LED light and a computer screens, which contains a lot of high-energy, short-wave and irregular frequency blue lights. High energy visible light (HEV) often refers to a short wavelength visible light, wherein HEV has a variety of impact damages for the human eye, and particularly in the blue lights with wavelengths between 380 nm to 500 nm, it has a greatest damage to the human's retina. Since the blue light has a short wavelength and a high energy, it can penetrate the eyes' lens directly and reach the human's retina. If the blue light penetrates to the human's retina, free radicals will produces on the human's retina, so these free radicals will cause the decline of the retinal pigment epithelial cell, wherein the decline of the epithelial cells will cause the decline of light-sensitive cells to lack of nutrients and causing the impairment of vision. And, this injury (impairment of vision) is irreversible. So the blue light is not only likely to cause the fatigue of the vision, but also can easily cause a macular degeneration. And, the macular degeneration almost becomes the number one killer of human vision in the world. Although the human eye's has an ability to filter UV and some blue lights, the ability to filter blue eyes will be reduced according to the growing age.

Currently, there are a lot of ultraviolet-protective glasses has different functions in the market, such as coating a layer of urethane acrylate/SiO2 nan-composite on lens of the UV glasses to enhance the scratch-resistant ability of the lens. In addition, it is able to coat a waterproof-medicine layer on the lens of the UV glasses to improve the easy-cleaning ability thereof and maintain with a good transparency. However, almost all of the lens are only considered for the protection of the transmittance of the UV and visible light, there are not considered to protect the transmittance of the short wavelength visible lights, and especially there are not considered to protective the transmittance of the short wavelength blue lights which have the worst damage of the human eye.

### SUMMARY OF THE PRESENT INVENTION

A main object of the present invention is provided a blue-light-inhibiting resin lens, wherein the blue-light-inhibiting lens is not only able to inhibit the transmittance of the blue lights, but also able to reduce the absorption and the reflection of the visible light, so as to reduce the damage for the human's eye from the blue light and the ultraviolet light.

Another object of the present invention is to provide a manufacturing method for a blue-light-inhibiting resin lens, wherein the manufacturing method can produce a blue-light-inhibiting lens which maintains to distinguish the contour of the objects and reduce the stimulation from the blue lights.

Accordingly, the above mentioned objects can be achieved through the following technical solutions:

A blue light inhibiting resin lenses comprises a reinforcing protective layer and a reinforcing layer coating on a side surface of the reinforcing protective layer from lower to upper followed by a vacuum evaporation method, wherein the reinforcing layer comprises eight layers, which comprises a first layer, a coating layer mixing with urethane acrylate and SiO2 nano-composite, and a second layer, a SiO2 layer I, and a third layer, a ZrO2 layer I, and a fourth layer, a SiO2 layer II, and a fifth layer, a ZrO2 layer II, and a sixth layer, an nano-indium-tin oxide layer, and a seventh layer, SiO2 layer III, and an eighth layer, a waterproof—medicine layer.

It is worth mentioning that another reinforcing layer is adapted to coat on another side surface of the reinforcing protective layer followed by a vacuum evaporation method, wherein the other reinforcing layer comprises the same structure as the opposite side reinforcing layer, which also comprises a first layer, a coating layer mixing with urethane acrylate and SiO2 nano-composite, and a second layer, a SiO2 layer I, and a third layer, a ZrO2 layer I, and a fourth layer, a SiO2 layer II, and a fifth layer, a ZrO2 layer II, and a sixth layer, an nano-indium-tin oxide layer, and a seventh layer, SiO2 layer III, and an eighth layer, a waterproof—medicine layer.

In addition, the reinforcing layer and the opposite reinforcing layer are a symmetry structure, and the thickness of each layer of the reinforcing layer is the same as the thickness of each layer of the opposite reinforcing layer.

Preferably, the coating layer with urethane acrylate and SiO2 nano-composite has a thickness of 2985 to 3015 Å (angstroms), and more preferably is 3000 angstroms.

Preferably, the thickness of the SiO2 layer I is 1713 to 1743 Å, and the thickness of the SiO2 layer II is 175 to 205 angstroms, and the thickness of SiO2 layer III is 835 to 865 angstroms, and more preferably, the SiO2 layer I has a thickness of 1728 angstroms, and the thickness of the SiO2 layer II is 190 angstroms, and the thickness of the SiO2 layer III is 850 angstroms.

Preferably, the ZrO2 layer has a thickness of 168 to 198 angstroms, and the thickness of the ZrO2 layer II is 735 to 765 angstroms, and more preferably, the thickness of the ZrO2 layer I is 183 Å, and the thickness of the ZrO2 layer II is 750 angstroms.

Preferably, the thickness of the nano-indium-tin oxide metal is 835 to 865 angstroms, and more preferably, the thickness thereof is 850 angstroms.

Preferably, the thickness of the waterproof-medicine layer is 10 to 40 angstroms, and more preferably, the thickness thereof is 25 angstroms.

Preferably, the substrate of the lens is a sunglass lens substrate, the substrate for the presbyopia lenses, and the substrate for the protective lenses or optical lens.

Compared with the prior art, the present invention has the following advantages:

The present is adapted to an eight-layer structure, which provides extremely effective absorption of blue light and high energy ultraviolet radiation to significantly reduce the damage for human's eye. At the same time, the lens of the present invention has a high transmittance and color fidelity to effectively screen the electromagnetic radiations. In addition, the lens of the present invention has the excellent compressive strength, the heat resistance and the scratch resistance.

The present invention provides a blue light inhibiting resin lenses comprises a reinforcing protective substrate coated with a blue light inhibiting staining materials for inhibit the transmittance of the blue light (Tsb) to lower than 5% through a vacuum coating method, such that the transmittance of the visible lights with wavelengths less than 500 nm slightly decrease, as well as that the transmittance of the visible lights with wavelengths large than 600 increases to above 90%. And, the transmittance of the visible lights with wavelengths between 500 nm to 600 nm is a transition. Meanwhile, in order to meet the requirements for night driving, the present invention is adapted to satisfy the requirement to distinguish the traffic lights.

According to the above described structure, the transmittances of the visible lights with wavelengths below 500 nm are decreased, and the transmittances of the visible lights with wavelengths above 600 nm are increased. Since the wavelength of the visible lights is between 350 nm to 700 nm, the wavelength of the visible lights less than 500 nm are almost purple lights and blue lights, which cause the worst damage to the human's eyes. So, after the nature lights pass through the lens of the present invention, the remaining light rays are almost yellow, green, and red light rays, so the image is more clearer to meet the actual needs of the lens.

A manufacturing method for a blue light inhibiting resin lens according to the above preferred embodiment of the present invention comprises steps of:

a. providing a glass-plastic mold, and adding a predetermined proportion of IIP initiator, an ultraviolet absorber, and a catechol solution into the allyl diglycol carbonates monomer, and stirring to form a preparation mixture, and pouring the preparation mixture into the glass-plastic mold for 20 hours by a nonlinear curve separation method, and separating the glass mold and a raw lens, and cleaning the raw lens to process the above described steps again so as to obtain a reinforcing protective substrate;

b. selecting a raw AC lens with UV400 protection as a reinforcing protective substrate;

c. selecting a raw PC lens with UV400 protection as a reinforcing protective substrate;

d. selecting a raw 1.56 resin lens chosen with UV400 protection as a reinforcing protective substrate;

e. selecting a 1.61 raw and dyeable lens with UV400 protection as a reinforcing protective substrate;

f. preparing a staining solution, and heating the staining solution at a constant temperature between to 92 to 95 degrees, and cleaning the above described reinforcing protective substrate (reinforcing protective substrate from steps a, b, c, d, and e), and placing the reinforcing protective substrate into the staining solution of BLUEBLOCKER from OMS for dyeing and reinforcing, so as to obtain a stained reinforcing protective substrate; and

g. cleaning the stained reinforcing protective substrate by an automatic cleaning equipment, and placing the stained reinforcing protective substrate into the polyurethane acrylates and SiO2 nano-composite to harden the stained reinforcing protective substrate, and then heating the stained reinforcing protective substrate in an oven on a tray at a heating temperature, and placing the stained reinforcing protective substrate into a vacuum coating machine for vacuum coating after heating, and sequentially coating a SiO2 layers, a ZrO2 layers, a SiO2 layers, a ZrO2 layers, an indium-tin oxide layers, a SiO2 layers, and a waterproof-medicine layers on a surface of the stained reinforcing protective substrate.

Accordingly, IPP initiator is preferred a di-isopropyl peroxydicarbonate, and the ultraviolet absorber is a UV powder, wherein the proportion of the allyl diglycol carbonate monomers, IPP initiator, and an ultraviolet absorber in the preparation mixture is 96.50:3:0.02:0.48. And, the preparation mixture is stirring for at least 1 hour, and then placed in a low temperature of 6 to 8 degrees with continuous stirring. At the same time, the residual air is extracted from the preparation mixture.

Accordingly, the heating temperature is preferably adjusted to 40 degrees for 3 to 5 hours, and then adjusted to 60 degrees for 5 to 8 hours, and then adjusted to 70 degrees for 1 to 2 hours, and finally adjusted to 88 for 2 to 3 hours to complete the heating process.

The present invention provides a blue light inhibiting resin lens has that the transmittance of the visible lights with wavelengths less than 500 nm is lower than 5%, and the transmittance of the visible lights with wavelengths large than 600 nm is large than 90%. Therefore, the blue light inhibiting resin lens can achieve the blue light protection and ensure and improve the ability to distinguish a contour of the objects

Additional advantages and features of the invention will become apparent from the description which follows, and may be realized by means of the instrumentalities and combinations particular point out in the appended claims.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a structural perspective view of a blue-light-inhibition resin lens according to a preferred embodiment of the present invention.

FIG. 2 is a block diagram according to the above preferred embodiment of the present invention, illustrating a manufacturing method for the blue-light-inhibition resin lens.

FIG. 3 is a table which describes a substantial experiment data including the relationship between the transmittance and different wavelengths of visible lights according to the above mentioned preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

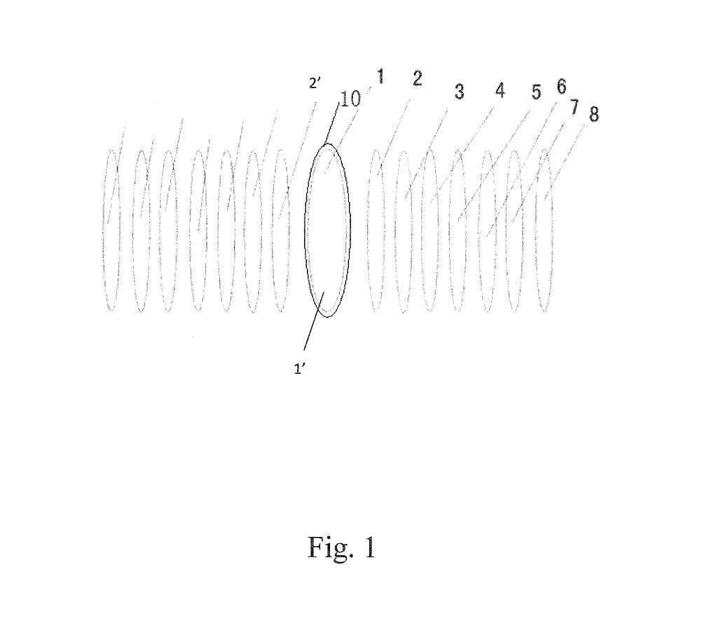

Referring to FIG. 1 of the drawings, a blue-light inhibiting resin lens according to a preferred embodiment of the present invention is illustrated, wherein the blue-light-inhibiting lens comprises a reinforcing protective substrate 1, and a reinforcing protective layers coating on a surface of reinforcing protective substrate 1 from lower to upper by a vacuum evaporation method, wherein the reinforcing protective substrate is coating with a special staining material so as to make it has a good blue light protective effect, and then the color-coated reinforcing protective substrate lens is hardened to obtain a hardened sheet, and finally the two opposite sides of the hardness sheet are coated with two reinforcing layers, wherein the reinforcing layer comprises a first layer, which is a nano-composite coating layer 2 mixing with polyurethane acrylate and SiO2, a second layer 3, which is a SiO2 layer I, a third layer 4, which is a ZrO2 layer I, a fourth layer 5, which is a SiO2 layer II, a fifth layer 6, which is a ZrO2 layer II, a sixth layer 7, which is an indium oxide nano-coating layer, and a seventh layer 8, which is a SiO2 Layer III, and an eighth layer 9, which is a waterproof-medicine layer. Wherein, thickness of the first layer 2 of polyurethane acrylate and SiO2 nano-composite coating layer is 3000 Angstroms, and the thickness of the second layer of SiO2 layer I is 1728 Angstroms, and the thickness of the third layer 4 of ZrO2 layer I is 183 angstroms, and the thickness of the fourth layer 5 of SiO2 layer II is 190 angstroms, and thickness of the fifth layer 6 of ZrO2 layer II is 750 angstroms, and the thickness of the sixth layer 7 of indium-tin oxide nano-coating layer is 850 angstroms, and the thickness of the seventh layer 8 of SiO2 layer III is 850 angstroms III, and a thickness of the eighth layer 9 of a waterproof-medicine layer is 25 angstroms.

It is worth mentioning that the reinforcing layer has the transmittance of lower than 5% for the visible light with a wavelength lower than 500 nm, and has the transmittance of larger than 90% for the visible light with a wavelength larger than 600 nm.

According to a preferred embodiment of the present invention, the requirement of the transmittance of the lens is based on the coating materials and coating method for the lens. Of course, it is able to achieve the required transmittance by directly staining the lens. The present invention disclosures a staining material is coated on both sides surface of the and the reinforcing protective substrate, but only a single side coated with staining material is also embodied in the present invention.

Accordingly, the reinforcing protective substrate 1 is made of CR39 resin and a catechol substrate, wherein and the polyurethane acrylate and SiO2 nano-composite coating layer 2 has a good tensile and impact strength ability to improve the strength of the present invention, wherein the above described layer which contains SiO2 and ZrO2 can improve the abrasion resistance, heat resistance, and transmittance of the lens, wherein the indium-tin oxide nano-coating layer 7 has a good conductivity and transparency, such that the lens can inhibit harmful electronic radiations, ultraviolet and far infrared. The waterproof-medicine layer 9 can facilitate the cleanness steps for the lenses, which is able to reduce dust attached on resin lenses. According to the above described lens, the present invention can not only effectively absorb a high-energy blue light and ultraviolet light, but also greatly reduce the damages for the human's eyes, and has an excellent compressing resistance ability, scratching resistance ability, and high temperature resistance property.

The indium-tin nano-coating layer oxide 7 is a ITO layer, which is a conductive layer attached on the lens, such that the insulating lens will become a conductor with a certain resistance based on coating a ITO layer thereon, so as to release the injury for the electromagnetic radiation to the human's eyes.

The waterproof-medicine layer 9 is made of ethyl silicone, which provides oil-resistance and dust resistance ability, so as to facilitate the user to clean the lens, and the dusts are not easy to attach thereon. High-fluorine and high-carbon compounds, such as DSX, can also be used to improve the anti-oil ability.

The ZrO2 layer and the SiO2 layer are two different refractive index materials, so the combination of these two layers can improve and reduce the transmittance of different wavelengths of the lens. And, the ITO layer has a high refractive index. Therefore, different refractive index materials can control different transmittance of different wavelengths of the lens. And, the conductive of the ITO can be used to screen the electromagnetic radiation.

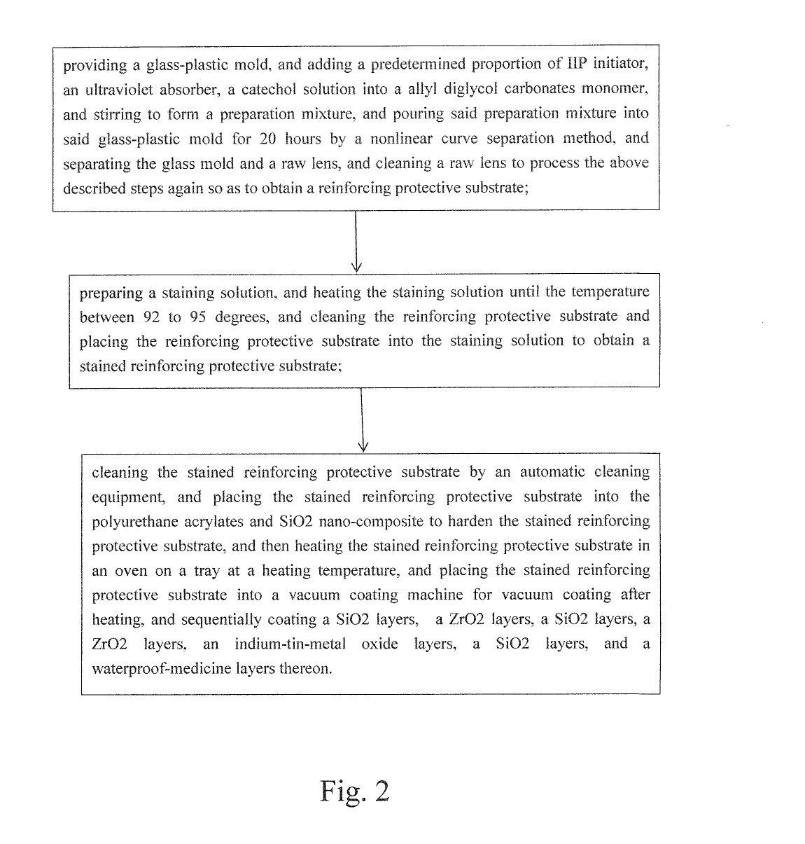

Referring to FIG. 2 of the drawings, a manufacturing method for a blue light inhibiting resin lens according to the above preferred embodiment of the present invention comprises steps of:

a. providing a glass-plastic mold, and adding a predetermined proportion of IIP initiator, an ultraviolet absorber, and a catechol solution into the allyl diglycol carbonates monomer, and stirring to form a preparation mixture, and pouring the preparation mixture into the glass-plastic mold for 20 hours by a nonlinear curve separation method, and separating the glass mold and a raw lens, and cleaning raw lens to process the above described steps again so as to obtain a reinforcing protective substrate; wherein the ultraviolet absorber is able to prevent the damage of the eyes from ultraviolet light, and the catechol solution is able to prevent the damage of the eye's form the blue light.

b. preparing a staining solution, and heating the staining solution until the temperature between 92 to 95 degrees, and cleaning the reinforcing protective substrate 1 and placing the reinforcing protective substrate 1 into the staining solution to obtain a stained reinforcing protective substrate 10;

c. cleaning the stained reinforcing protective substrate 10 by an automatic cleaning equipment, and placing the stained reinforcing protective substrate 10 into the polyurethane acrylates and SiO2 nano-composite to harden the stained reinforcing protective substrate 10, and then heating the stained reinforcing protective substrate 10 in an oven on a tray at a heating temperature, and placing the stained reinforcing protective substrate 10 into a vacuum coating machine for vacuum coating after heating, and sequentially coating SiO2 layers 2, 2′, ZrO2 layers 3,3′, SiO2 layers 4,4′, ZrO2 layers 5,5′, indium-tin-metal oxide layers 6,6′, SiO2 layers 7,7′, and waterproof-medicine layers 8,8′ on symmetry side surfaces of the stained reinforcing protective substrate 10.

Accordingly, IPP initiator is preferred a di-isopropyl peroxydicarbonate or V65, and the ultraviolet absorber is a UV powder, wherein the proportion of the allyl diglycol carbonate monomers, IPP initiator, and an ultraviolet absorber in the preparation mixture is 96.50:3:0.02:0.48. And, the preparation mixture is stirring for at least 1 hour, and then placed in a low temperature of 6 to 8 degrees with continuous stirring. At the same time, the residual air is extracted from the preparation mixture.

Accordingly, the heating temperature is preferably adjusted to 40 degrees for 3 to 5 hours, and then adjusted to 60 degrees for 5 to 8 hours, and then adjusted to 70 degrees for 1 to 2 hours, and finally adjusted to 88 for 2 to 3 hours to complete the heating process.

The staining solution of the present invention is a BLUE-BLOCK staining solution imported from Canada OMS's. The surfaces of the completed AC (acrylic), PC (polycarbonate), or resin lens are coated by a special water-based staining material under a certain temperature, concentration and dyeing time. The temperature is 92 to 96 degrees, and the concentration is 3 to 8% (volume ratio, based on the specific requirement of the barrier of the blue light), and the dyeing time is 15 to 40 minutes. It should be noted that the above described temperature, concentration, and dyeing time can be adjust with respect to the related parameters of the embodiment.

The reinforcing protective substrate 1 can be an AC or a PC lens, wherein the three parameters, temperature, concentration, and dyeing time, can be adjusted based on the strength of the blue lights.

The catechol solution of the present invention provides to prevent anti-blue light effects to the resin lens. The present invention provides a glass-plastic mold, and adding a predetermined proportion of IIP initiator, an ultraviolet absorber, and a catechol solution into the allyl diglycol carbonates monomer, and stirring to form a preparation mixture, and pouring the preparation mixture into the glass-plastic mold for 20 hours by a nonlinear curve separation method, and separating the glass-plastic mold and a raw lens, and cleaning raw lens to process the above described steps again so as to obtain a reinforcing protective substrate.

According to the transmittance test, the blue light inhibiting resin lens according to the preferred embodiment of the present invention can completely inhibit the high energy light rays, which have wavelengths below 500 nm, and the transmittance of the visible light of the wavelength between 380 nm to 500 nm is 3%. The transmittance of the visible light with a wavelength of 600 nm is above 90%. Therefore, the present invention not only inhibits the strong lights, but also clarifies the contour of the objects. In addition, the blue light inhibiting resin lens is adapted to satisfy the requirement of the traffic lights. The present invention includes the advantages of the CR39 lenses, such as easy to cut, having a good impact resistance and weather resistance. So, the blue light inhibiting resin lens can inhibit the ultraviolet light and the computer radiation, and the transmittance rate is moderate to provide the driver when they are driving and even wearing in house.

The present invention provides a blue light inhibiting resin lens which comprises the reinforcing protective substrate coating with a catechol material and a special staining material (BLUE-BLOCKER staining solution), and further coating a reinforcing layer on a side surface of the reinforcing protective substrate. The reinforcing layer are the SiO2 layer 2, the ZrO2 layer 3, the SiO2 layer II 4, the ZrO2 layer II 5, the indium-tin oxide layer 6, the SiO2 layer III 7, and a waterproof medicine layer 8. In addition, another reinforcing layer also can be coated on the opposite side surface of the reinforcing protective substrate to form the SiO2 layer 2′, the ZrO2 layer 3′, the SiO2 layer II 4′, the ZrO2 layer II 5′, the indium-tin oxide layer 6′, the SiO2 layer III 7′, and the waterproof medicine layer 8′.

The ZrO2 and SiO2 layers provide different refractive indexes and thickness to control the transmittance from different wavelengths of the visible lights. The indium-tin oxide layer 6 (ITO) layer is able to screen the electromagnetic radiation based on the control of the transmittance, and a waterproof-medicine layer 8 provides a dust resistance and oil resistance ability to improve the ability for cleaning the blue light inhibiting resin lens of the present invention and reduce environmental dusts attached thereon. Therefore, the present invention can effectively screen the electromagnetic radiation, and decrease the absorption and reflection of visible lights excluding blue lights, and finally reduce the damage for the human's eyes of the ultraviolet lights and blue lights

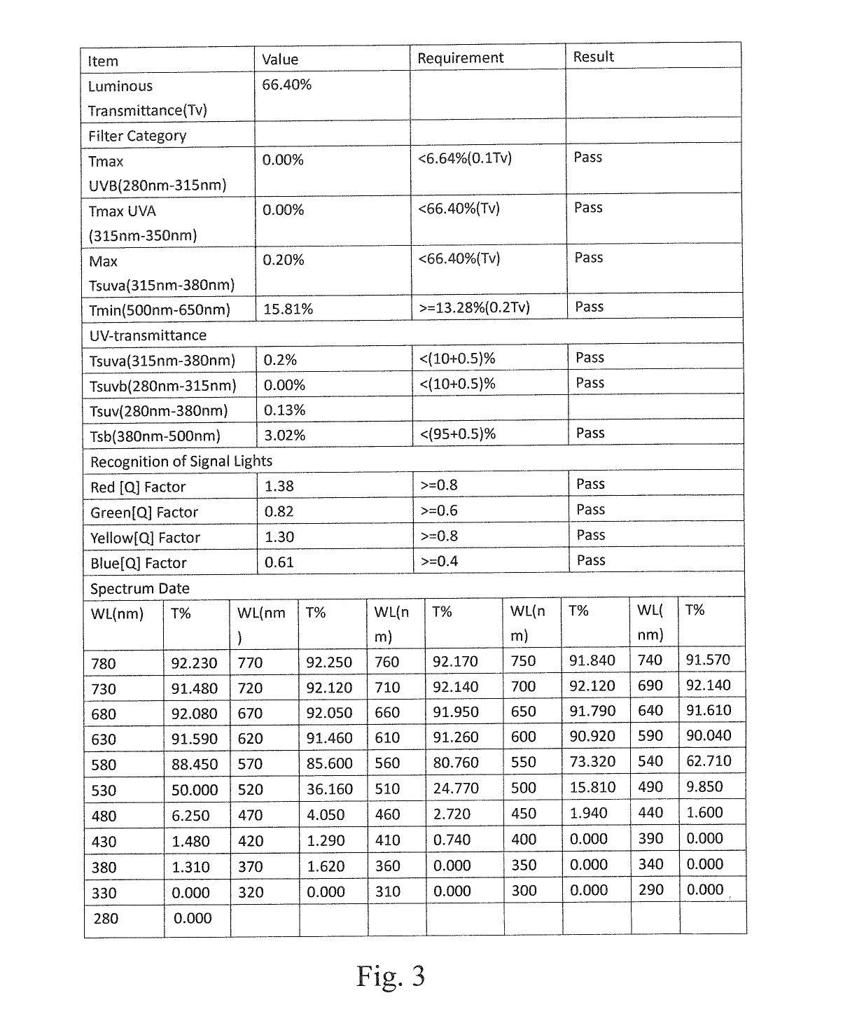

Referring to FIG. 3 of the drawings, the transmittance of the blue light (Tsb) is approximately 3%, and the transmittance of the visible light with wavelengths below 500 nm is less than 5%, and the transmittance of the visible light with wavelengths larger than 600 nm is larger than 90%.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A blue-light-inhibiting resin lens, comprising:
a reinforcing protective substrate;
a reinforcing layer which comprises eight layers coating on a surface of said reinforcing protective substrate from lower to upper by a vacuum evaporation method; wherein;
said reinforcing layer comprises a first layer, which is a nano-composite coating layer mixing with polyurethane acrylate and SiO2, a second layer, which is a SiO2 layer I, a third layer, which is a ZrO2 layer I, a fourth layer, which is a SiO2 layer II, a fifth layer, which is a ZrO2 layer II, a sixth layer, which is an indium-tin oxide nano-coating layer, and a seventh layer, which is a SiO2 Layer III, and an eighth layer, which is a waterproof-medicine layer.

2. The lens, as recited in claim 1, further comprising another reinforcing layer coated on an opposite side surface of said reinforcing protective substrate, wherein said another reinforcing layer comprises a first layer, which is a nano-composite coating layer mixing with polyurethane acrylate and SiO2, a second layer, which is a SiO2 layer I, a third layer, which is a ZrO2 layer I, a fourth layer, which is a SiO2 layer II, a fifth layer, which is a ZrO2 layer II, a sixth layer, which is an indium-tin-metal oxide nano-coating layer, and a seventh layer, which is a SiO2 Layer III, and an eighth layer, which is a waterproof-medicine layer.

3. The lens, as recited in claim 1, wherein a thickness of said first layer of polyurethane acrylate and SiO2 nano-composite coating layer is 2985 to 3015 Angstroms.

4. The lens, as recited in claim 2, wherein a thickness of said first layer of polyurethane acrylate and SiO2 nano-composite coating layer is 2985 to 3015 Angstroms.

5. The lens, as recited in claim 1, wherein a thickness of said second layer of SiO2 layer I is 1713 to 1743 Angstroms, and a thickness of said fourth layer of SiO2 layer II is 175 to 205 angstroms, and a thickness of said seventh layer of SiO2 layer III is 835 to 865 angstroms.

6. The lens, as recited in claim 2, wherein a thickness of said second layer of SiO2 layer I is 1713 to 1743 Angstroms, and a thickness of said fourth layer of SiO2 layer II is 175 to 205 angstroms, and a thickness of said seventh layer of SiO2 layer III is 835 to 865 angstroms.

7. The lens, as recited in claim 1, wherein a thickness of said third layer of ZrO2 layer I is 168 to 198 angstroms, and thickness of said fifth layer of ZrO2 layer II is 735 to 765 angstroms.

8. The lens, as recited in claim 2, wherein a thickness of said third layer of ZrO2 layer I is 168 to 198 angstroms, and thickness of said fifth layer of ZrO2 layer II is 735 to 765 angstroms.

9. The lens, as recited in claim 1, wherein a thickness of said sixth layer of indium-tin oxide nano-coating layer is 835 to 865 angstroms.

10. The lens, as recited in claim 2, wherein a thickness of said sixth layer of indium-tin oxide nano-coating layer is 835 to 865 angstroms.

11. The lens, as recited in claim 1, wherein a thickness of said eighth layer of a waterproof-medicine layer is 10 to 40 angstroms.

12. The lens, as recited in claim 2, wherein a thickness of said eighth layer of a waterproof-medicine layer is 10 to 40 angstroms.

13. The lens, as recited in claim 1, wherein said protective lens substrate is selected by a group consisting a sunglasses lens substrate, a presbyopia lens substrate, a protective lens substrate and an optical lens substrate.

14. The lens, as recited in claim 2, wherein said protective lens substrate is selected by a group consisting a sunglasses lens substrate, a presbyopia lens substrate, a protective lens substrate and an optical lens substrate.

15. A manufacturing method for a blue light inhibiting resin lens comprising steps of:
a. providing a glass-plastic mold, and adding a predetermined proportion of IIP initiator, an ultraviolet absorber, and a catechol solution into a allyl diglycol carbonates monomer, and stirring to form a preparation mixture, and pouring said preparation mixture into said glass-plastic mold for 20 hours by a nonlinear curve separation method, and separating the glass mold and a raw lens, and cleaning said raw lens to process the above described steps again so as to obtain a reinforcing protective substrate;
b. preparing a staining solution, and heating said staining solution until the temperature between 92 to 95 degrees, and cleaning said reinforcing protective substrate and placing said reinforcing protective substrate into said staining solution to obtain a stained reinforcing protective substrate;
c. cleaning said stained reinforcing protective substrate by an automatic cleaning equipment, and placing said stained reinforcing protective substrate into the polyurethane acrylates and SiO2 nano-composite to harden said stained reinforcing protective substrate, and then heating said stained reinforcing protective substrate in an oven on a tray at a heating temperature, and placing said stained reinforcing protective substrate into a vacuum coating machine for vacuum coating after heating, and sequentially coating a SiO2 layers, a ZrO2 layers, a SiO2 layers, a ZrO2 layers, an indium-tin-metal oxide layers, a SiO2 layers, and a waterproof-medicine layers thereon.

16. The manufacturing method, as recited in claim 15, wherein said IPP initiator is selected by a group consisting of di-isopropyl peroxydicarbonate and V65.

17. The manufacturing method, as recited in claim 15, wherein said ultraviolet absorber is a UV powder.

18. The manufacturing method, as recited in claim 15, wherein a proportion of said allyl diglycol carbonate monomers, said IPP initiator, and said ultraviolet absorber in said preparation mixture is 96.50:3:0.02:0.48.

19. The manufacturing method, as recited in claim 15, wherein said preparation mixture is stirring for at least 1 hour, and then placed in a low temperature of 6 to 8 degrees with continuous stirring to extract the residual air from said preparation mixture.

20. The manufacturing method, as recited in claim 15, wherein said heating temperature is adjusted to 40 degrees for 3 to 5 hours, and then adjusted to 60 degrees for 5 to 8 hours, and then adjusted to 70 degrees for 1 to 2 hours, and finally adjusted to 88 for 2 to 3 hours to complete the heating process.

21. The manufacturing method, as recited in claim 15, wherein said staining solution is a BLUE-BLOCK staining solution imported from Canada OMS's BLUE-BLOCKER.

22. The manufacturing method, as recited in claim 15, wherein said reinforcing protective substrate is selected by a group consisting of an AC (acrylic) lens, a PC (polycarbonate) lens, a 1.56 resin lens, and a 1.61 dyeable resin lens.
